(19) United States
(12) Patent Application Publication
(10) Pub. No.: US 2014/0288356 A1
(43) Pub. Date: Sep. 25, 2014

(54) ASSESSING AUDITORY PROSTHESIS ACTUATOR PERFORMANCE

(71) Applicant: Jurgen VAN VLEM, Borgerhout (BE)

(72) Inventor: Jurgen VAN VLEM, Borgerhout (BE)

(21) Appl. No.: 14/208,774

(22) Filed: Mar. 13, 2014

Related U.S. Application Data
(60) Provisional application No. 61/793,807, filed on Mar. 15, 2013.

(51) Int. Cl. H04R 25/00

(52) U.S. Cl. CPC H04R 25/305; H04R 25/606
USPC 600/25

(57) ABSTRACT

A computer-implemented method including energizing an actuator of an auditory prosthesis with a driving signal, de-energizing the actuator, obtaining information indicative of a momentum-indicative parameter of the actuator while the actuator is de-energized, and evaluating the obtained information, and assessing actuator performance based on the action of evaluating.

### CROSS-REFERENCE TO RELATED APPLICATIONS

This patent application claims priority to U.S. Provisional Patent Application No. 61/793,807, having the same title as that captioned above, filed on Mar. 15, 2013, naming Jurgen van Vlem as an inventor, the entire contents of that application being incorporated herein by reference in its entirety.

### BACKGROUND

1. Field of the Disclosure

The present technology relates generally to auditory prostheses, and more particularly to auditory prostheses configured to apply mechanical stimulation.

2. Related Art

Hearing loss, which may be due to many different causes, is generally of two types, conductive and sensorineural. Conductive hearing loss occurs when the normal mechanical pathways of the outer and/or middle ear are impeded, for example, by damage to the ossicular chain or ear canal. Sensorineural hearing loss occurs when there is damage to the inner ear, or to the nerve pathways from the inner ear to the brain.

Individuals suffering from conductive hearing loss typically receive an acoustic hearing aid. Hearing aids rely on principles of air conduction to transmit acoustic signals to the cochlea. Individuals who suffer from conductive hearing loss typically have some form of residual hearing because the hair cells in the cochlea are undamaged. As a result, individuals suffering from conductive hearing loss might receive an auditory prosthesis that generates mechanical motion of the cochlea fluid instead of a hearing aid based on the type of conductive loss, amount of hearing loss and customer preference. Such prostheses include, for example, bone conduction devices and direct acoustic stimulators.

In contrast to acoustic hearing aids, certain types of auditory prostheses, commonly referred to as bone conduction devices, convert a received sound into vibrations. The vibrations are transferred through teeth and/or bone to the cochlea, causing generation of nerve impulses, which result in the perception of the received sound. Bone conduction devices are suitable to treat a variety of types of hearing loss and may be suitable for individuals who cannot derive sufficient benefit from acoustic hearing aids, cochlear implants, etc., or for individuals who suffer from stuttering problems. Bone conduction devices may be coupled using a direct percutaneous implant and abutment, or using transcutaneous solutions, which can contain an active or passive implant component, or other mechanisms to transmit sound vibrations through the skull bones, such as through vibrating the ear canal walls or the teeth.

Unfortunately, not all individuals suffering from conductive hearing loss are able to derive suitable benefit from acoustic hearing aids. For example, some individuals are prone to chronic inflammation or infection of the ear canal. Other individuals have malformed or absent outer ear and/or ear canals resulting from a birth defect or medical conditions such as Treacher Collins syndrome or Microtia. For these and other individuals, another type of auditory prosthesis referred to as a mechanical stimulation auditory prosthesis, may be suitable. Such auditory prostheses include, for example, bone conduction devices and middle ear implants.

### SUMMARY

In one aspect of the present technology, there is provided a computer-implemented method of assessing performance of an actuator configured to deliver mechanical stimulation to a recipient and incorporated in an auditory prosthesis. Such a method includes: energizing the actuator with a driving signal; de-energizing the actuator; measuring one or more values of a momentum-indicative parameter of the actuator while the actuator is de-energized; and evaluating the one or more measured values in order to assess the performance of the actuator.

In yet another aspect of the present technology, there is provided an auditory prosthesis for applying mechanical stimulation to a recipient to cause a hearing percept, the prosthesis comprising: an actuator configured to generate mechanical vibrations in response to driving signals; a driver configured to deliver the driving signal to the actuator to cause actuation thereof; a measurement circuit configured to measure one or more values of a momentum-indicative parameter of the actuator; and a control circuit. Such a control circuit is configured to: direct the driver to energize the actuator with a driving signal and then de-energize the actuator; direct the measurement circuit to measure the one or more values while the actuator is de-energized; and evaluate the one or more measured values against one or more reference values.

In another aspect of the present technology, there is provided a computer implemented method comprising: measuring an actuator parameter of an auditory prosthesis while the auditory prosthesis is in normal operation for a recipient and while the actuator is de-energized and adjusting the normal operation of the auditory prosthesis based on the measuring, wherein the measuring step is inaudible to the recipient.

### BRIEF DESCRIPTION OF THE DRAWINGS

Embodiments of the present technology are described below with reference to the attached drawings, in which:

FIG. 1 is perspective view of an individual's head in which an auditory prosthesis in accordance with embodiments of the present technology may be implemented;

FIG. 2A is a perspective view of an individual's head, implanted with an exemplary bone conduction device in accordance with an embodiment of the present technology;

FIG. 2B is a perspective view of an individual's head, implanted with an exemplary direct acoustic stimulator in accordance with an embodiment of the present technology;

FIG. 2C is a perspective view of an individual's head, implanted with another type of direct acoustic stimulator in accordance with another embodiment of the present technology;

FIG. 3A is a simplified block diagram of an internal component of an exemplary auditory prosthesis (such as in FIG. 2A) including a measuring arrangement, in accordance with an embodiment of the present technology;

FIG. 3B is a simplified block diagram of an internal component of an exemplary auditory prosthesis (such as in FIG. 2A or FIG. 2B) including a measurement circuit, in accordance with another embodiment of the present technology;

FIG. 4A illustrates waveforms representing an illustrative example of waveforms appearing on terminals of an actuator;

FIG. 4B illustrates another waveform representing an illustrative example of a waveform appearing on terminals of an actuator;

FIG. 4C illustrates that, during the off-duty phase of the duty cycle of FIG. 4B, the voltage resulting from back-EMF decays (or evanesces) according to e^{δt};

FIG. 4D illustrates an electromagnetic actuator simplified for purposes of modeling the decaying waveform of FIG. 4B according to Hooke's law; and

FIG. 5 is a flowchart illustrating a method of assessing performance of an actuator in an auditory prosthesis, in accordance with another embodiment of the present technology.

### DETAILED DESCRIPTION

Aspects of the present technology are generally directed to an auditory prosthesis comprising an actuator, e.g., an electromechanical actuator, configured to apply mechanical stimulation to a recipient to cause a hearing percept, and a driver configured to deliver a driving signal to the actuator to cause actuation thereof. The auditory prosthesis further comprises a measurement circuit configured to measure one or more values of a momentum-indicative parameter of the actuator, and a control circuit to assess how well the actuator is performing; that is, the quality of actuator performance. Such assessment can be utilitarian because the actuator can behave differently due to aging of its components and/or due to different environmental conditions. For example, due to fluctuations in environmental factors such as barometric pressure and temperature, the resonance frequencies of the actuator can correspondingly vary. As an auditory prosthesis is ‘fitted’ for a particular recipient, such variations in the behavior of the actuator can degrade the ‘fit’ of the auditory prosthesis, which can manifest as reduced output levels, over-stimulation at some frequencies, under-stimulation at some frequencies, reduced battery life, etc. Also, performance of the auditory prosthesis is dependent upon how well the actuator is coupled to the recipient (for example, via a bone, inner ear, middle ear, etc.). The quality of such a coupling cannot be fully evaluated until after the recipient substantially recovers from the implantation surgery, at which point the implantation is difficult to examine. Accordingly, such assessment also can be utilitarian because the quality of the actuator's performance can be used as an indication of the quality of the implantation. According to an embodiment of the present technology, the control circuit is configured to: direct the driver to energize the actuator with a driving signal and then de-energize the actuator; direct the measurement circuit to measure the one or more values while the actuator is de-energized; and evaluate the one or more values. According to another embodiment of the present technology, the control circuit is operable to adjust the operation of the auditory prosthesis based upon the assessment, e.g., by being further configured to: determine the driving signal (it being a first driving signal); adjust how a given driving signal is determined based on the evaluation; determine a second driving signal according to the adjustment; and direct the driver to energize the actuator with the second driving signal. According to an embodiment of the present technology, because the one or more values are measured while the actuator is de-energized, and because the duration of de-energization is too brief for the recipient to perceive any interruption in the normal operation of the auditory prosthesis, the recipient is unaware that such measurement has taken place. Here, normal operation refers to typical operation of the auditory prosthesis, i.e., the type of operation that is most typically exhibited by the auditory prosthesis. By contrast, for example in the circumstance of there being an ordinary test operation of the auditory prosthesis that was conducted infrequently and that could be initiated by the recipient (such that the recipient was made aware of the test operation being conducted), that involved the recipient's interaction with the auditory prosthesis (e.g., actuator a user interface, etc.) during the test, and/or that was conducted in a manner of which the recipient was aware (e.g., because of temporarily diminished hearing enhancement capability while the test was ongoing), then such testing would be regarded as an example of ordinary operation of the auditory prosthesis, but would not be regarded as a normal operation in the sense of the type of operation of the auditory prosthesis that most typically occurs. Stated otherwise, the measurement is inaudible. In this respect, such measurement can be described as stealth measurement vis-à-vis the recipient's perception of sound as well as the recipient's awareness of the ‘normal’ operation of the auditory prosthesis.

One or more embodiments of the present technology can be used to measure device and coupling performance: in a real-time context while the recipient is in a clinical setting; or outside the clinical setting for subsequent, i.e., non-real-time, e.g., continuously or at desired intervals, downloading to a home computer, a smartphone, etc. One or more embodiments of the present technology can be used to measure device and coupling performance and adjust the device driving signal immediately, e.g., without human interaction, whether in a clinical setting or outside a clinical setting.

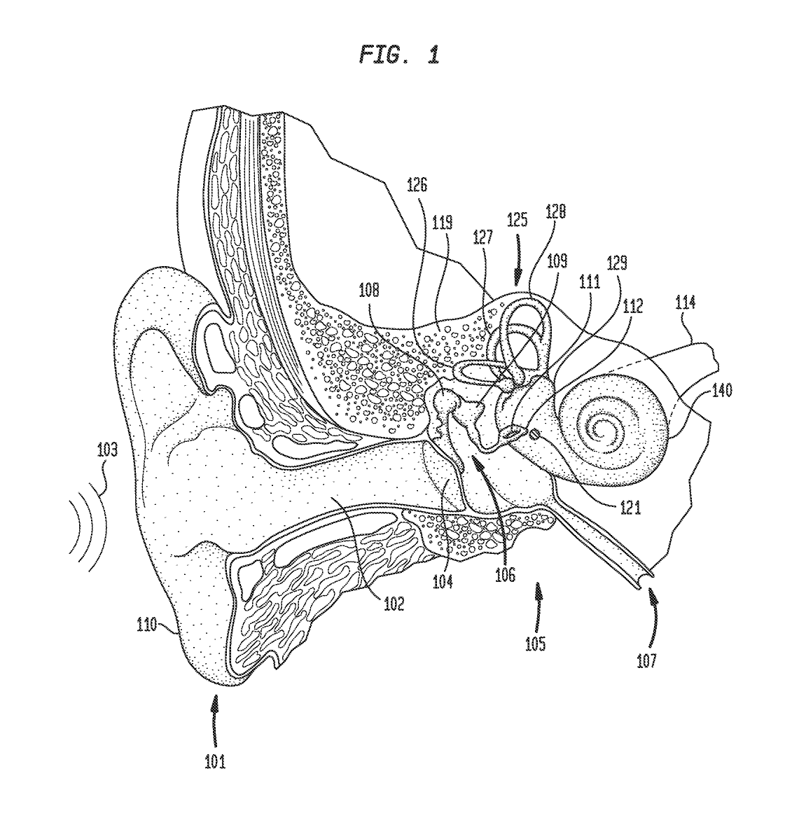

FIG. 1 is perspective view of an individual's head in which many be implemented an auditory prosthesis in accordance with embodiments of the present technology may be implemented. As shown in FIG. 1, the individual's hearing system comprises an outer ear 101, a middle ear 105 and an inner ear 107. In a fully functional ear, outer ear 101 comprises an auricle 110 and an ear canal 102. An acoustic pressure or sound wave 103 is collected by auricle 110 and channeled into and through ear canal 102. Disposed across the proximal end of ear canal 102 is a tympanic membrane 104 which vibrates in response to sound wave 103. This vibration is coupled to oval window or fenestra ovalis 112 through three bones of middle ear 105, collectively referred to as the ossicles 106 and comprising the malleus 108, the incus 109 and the stapes 111. Bones 108, 109 and 111 of middle ear 105 serve to filter and amplify sound wave 103, causing oval window 112 to articulate, or vibrate in response to vibration of tympanic membrane 104. This vibration sets up waves of fluid motion of the perilymph within cochlea 140. Such fluid motion, in turn, activates tiny hair cells (not shown) inside of cochlea 140. Activation of the hair cells causes appropriate nerve impulses to be generated and transferred through the spiral ganglion cells (not shown) and auditory nerve 114 to the brain (also not shown) where they are perceived as sound.

One type of auditory prosthesis that converts sound to mechanical stimulation in treating hearing loss is a bone conduction device, which bypass the outer and middle ear of the recipient and transmits vibrations directly to the cochlea. Another type of auditory prosthesis that converts sound to mechanical stimulation in treating hearing loss is a direct acoustic stimulator (also sometimes referred to as an “inner ear mechanical stimulation device” or “direct mechanical stimulator”), which bypass the outer ear of the recipient and transmit vibrations directly to the middle ear.

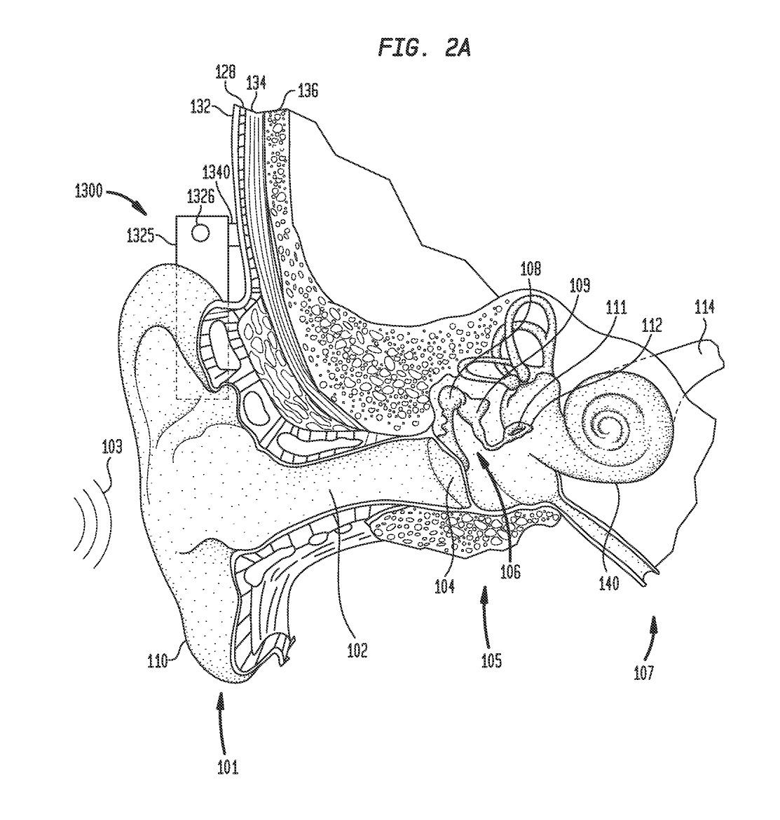

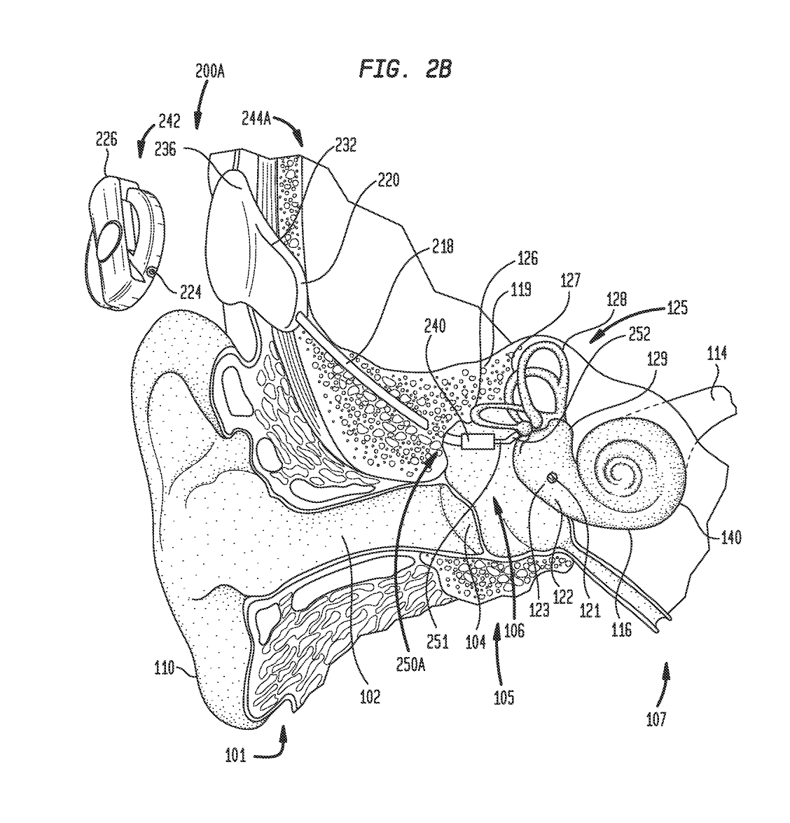

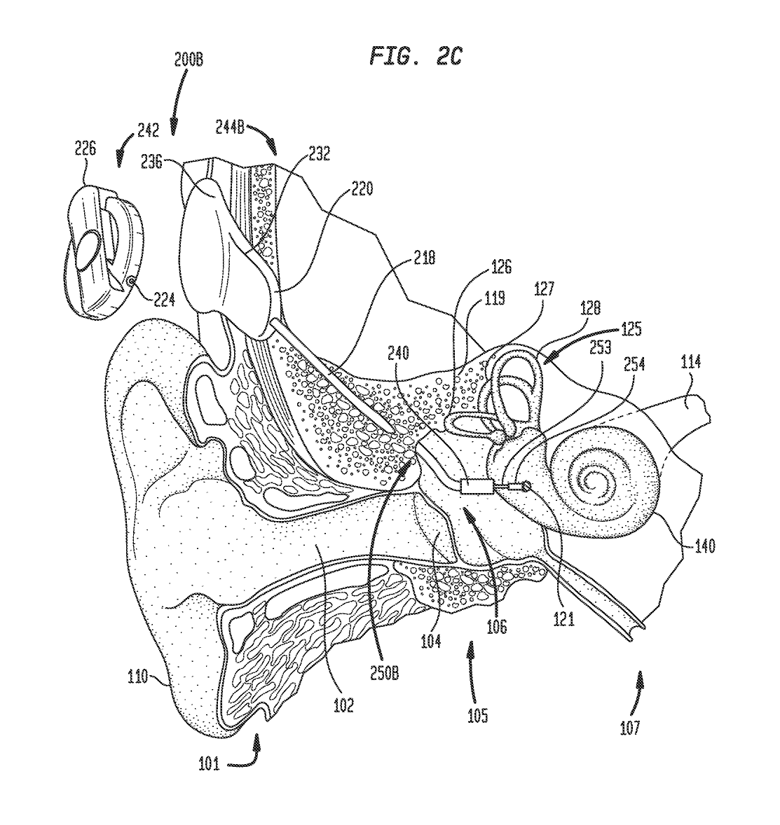

FIG. 2A is a perspective view of an individual's head, implanted with an exemplary bone conduction device 1300 in accordance with an embodiment of the present technology.

FIG. 2A also illustrates the positioning of bone conduction device 1300 relative to outer ear 101, middle ear 105 and inner ear 107 of a recipient of device 1300. As shown, bone conduction device 1300 is positioned behind outer ear 101 of the recipient. In the embodiment illustrated in FIG. 2A, bone conduction device 1300 comprises a housing 1325 having a sound input element 1326 positioned in, on or coupled to housing 1325. Sound input element 1326 is configured to receive sound signals and may comprise, for example, a microphone, telecoil, etc.

Bone conduction device 1300 comprises a sound processor, an actuator and/or various other electronic circuits/devices that facilitate operation of the device in the presently described embodiment. In an embodiment, e.g., the actuator is a piezoelectric actuator; however, in other embodiments, actuator can be any other suitable type actuator. Actuators are sometimes referred to as vibrators. Bone conduction device 1300 also comprises actuator drive components configured to generate and apply an electric field to the actuator. In certain embodiments, the actuator drive components comprise one or more linear amplifiers. For example, class D amplifiers or class G amplifiers may be utilized, in certain circumstances, with one or more passive filters. More particularly, sound signals are received by sound input element 1326 and converted to electrical signals. The electrical signals are processed and provided to the actuator that outputs a force for delivery to the recipient's skull to cause a hearing percept by the recipient.

Bone conduction device 1300 further includes a coupling 1340 configured to attach the device to the recipient. In the specific embodiments of FIG. 2A, coupling 1340 is attached to an anchor system (not shown) implanted in the recipient. In the illustrative arrangement of FIG. 2A, anchor system comprises a percutaneous abutment fixed to the recipient's skull bone 136. The abutment extends from bone 136 through muscle 134, fat 128 and skin 132 so that coupling 1340 can be attached thereto. Such a percutaneous abutment provides an attachment location for coupling 1340 that facilitates efficient transmission of mechanical force.

As noted, a bone conduction device, such as bone conduction device 1300, utilizes an actuator (also sometimes referred to as a vibrator) to generate a mechanical force for transmission to the recipient's skull. Bone conduction device 1300 uses the resonance peak(s) of the device in generating driving signals for generating the stimulation to be applied to the recipient in the presently described embodiment.

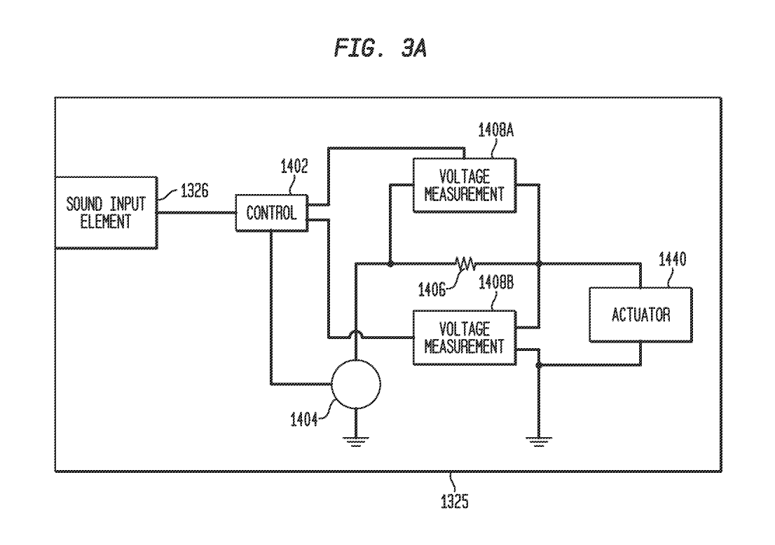

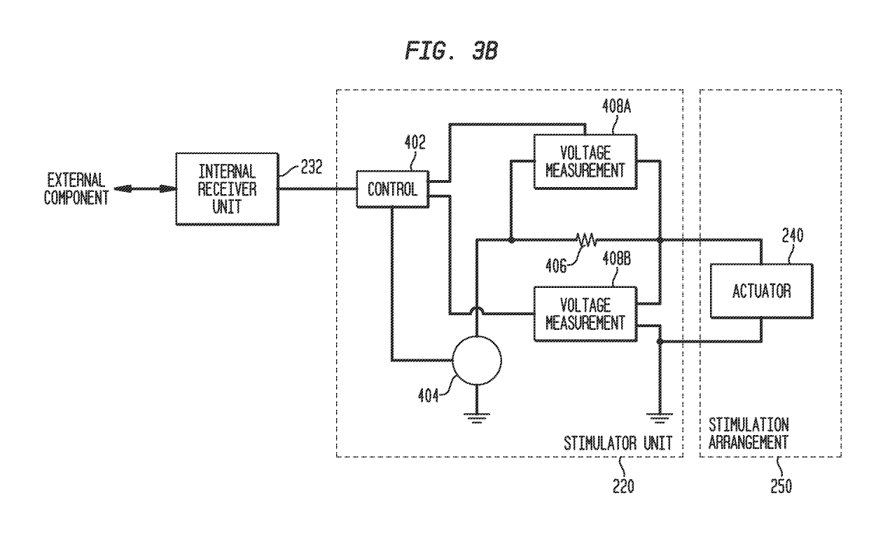

In FIG. 2A, bone conduction device 1300 comprises an arrangement for measuring values of a momentum-indicative parameter, e.g., such as that described in FIG. 3A, where FIG. 3A is a simplified block diagram of an internal component of another exemplary auditory prosthesis including a measuring arrangement, in accordance with an embodiment of the present technology. For ease of explanation, only those components of the bone conduction device that will be discussed below are illustrated in FIG. 3A, and in actual implementation additional components may be included, such as actuator drive components, etc.

As illustrated in FIG. 3A, housing 1325 includes a sound input element 1326, a control circuit 1402, a signal generator 1404, a resistor 1406, two voltage measurement circuits 1408A and 1408B, and an actuator 1440. Control circuit 1402 is a circuit (e.g., an Application Specific Integrated Circuit (ASIC)) configured for exercising control over the bone conduction device. For example, control circuit 1402 is configured for receiving, from the sound input element 1326, the sound signals and processing the sound signals to generate control signals for controlling signal generator in generating driving signals causing actuation of the actuator 1440 in the presently described embodiment. Control circuit 1402 takes into account the frequency response and resonant peak(s) of the actuator 1440 in determining the driving signals in the presently described embodiment.

Signal generator 1404 generates the driving signals for causing actuation of actuator 1440. In an embodiment, e.g., signal generator 1404 has an output impedance of 10 ohms in the presently described embodiment. In an embodiment, e.g., resistor 1406 is a standard resistor, such as, for example, a 2.3-ohm resistor. However, in other embodiments, resistor 1406 may be other types of resistive elements. A voltage measurement circuit 1408A is illustrated as connected to opposite ends of resistor 1406. Voltage measurement circuit 1408A can include any type of circuitry configured to output a signal indicative of the voltage across resistor 1406. As illustrated, voltage measurement circuit 1408A provides the measured voltage to control circuit 1402.

In embodiments, actuator 1440 is any type of suitable transducer configured to receive electrical signals and generate mechanical motion in response to the electrical signals. For example, in an embodiment, actuator 1440 is an electromagnetic actuator. A voltage measurement circuit 1408B is illustrated as connected on opposite sides of actuator 1440. As configured, voltage measurement circuit 1408B measures the voltage drop across actuator 1440. Voltage measurement circuit 1408B, in an embodiment, includes circuitry such as discussed above with reference to voltage measurement circuit 1408A for measuring and outputting the measured voltage. As illustrated, voltage measurement circuit 1408B provides the measured voltage to control circuit 1402. Although the illustrated embodiment includes two voltage measurement circuits 1408A and 1408B, in other embodiments only one of the voltage measurement circuits is included.

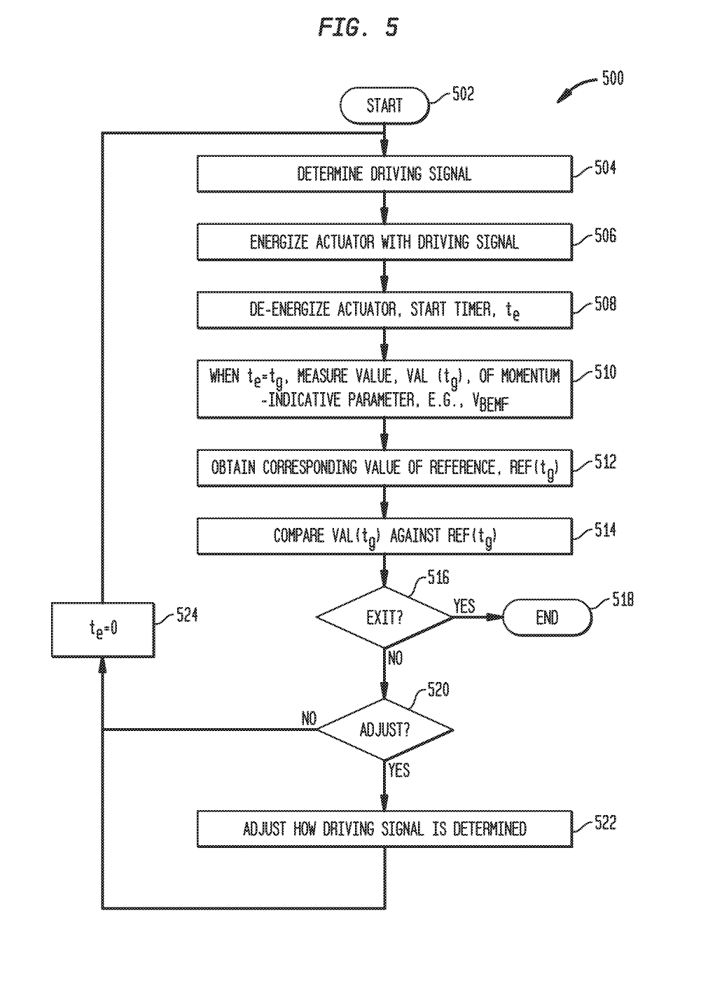

Control circuit 1402, signal generator 1404, and voltage measurement circuits 1408A and 1408B operate in a similar manner, in the presently described embodiment, to the similarly named components discussed below with reference to FIG. 3B (see below) in terms of measuring values of a momentum-indicative parameter. Accordingly, the operation of control circuit 1402, signal generator 1404, and voltage measurement circuits 1408A and 1408B, can be described in terms of flowchart 500 of FIG. 5 (see below).

FIG. 2B is a perspective view of an individual's head, implanted with an exemplary direct acoustic stimulator 200A in accordance with an embodiment of the present technology.

Direct acoustic stimulator 200A comprises an external component 242 that is directly or indirectly attached to the body of the recipient, and an internal component 244A that is temporarily or permanently implanted in the recipient. External component 242 typically comprises one or more sound input elements, such as microphones 224 for detecting sound, a sound processing unit 226, a power source (not shown), and an external transmitter unit (also not shown). The external transmitter unit is disposed on the exterior surface of sound processing unit 226 and comprises an external coil (not shown). Sound processing unit 226 processes the output of microphones 224 and generates encoded signals, sometimes referred to herein as encoded data signals, which are provided to the external transmitter unit. For ease of illustration, sound processing unit 226 is shown detached from the recipient.

Internal component 244A comprises an internal receiver unit 232, a stimulator unit 220, and a stimulation arrangement 250A. Internal receiver unit 232 and stimulator unit 220 are hermetically sealed within a biocompatible housing, sometimes collectively referred to herein as a stimulator/receiver unit.

Internal receiver unit 232 comprises an internal coil (not shown), and preferably, a magnet (also not shown) fixed relative to the internal coil. The external coil transmits electrical signals (i.e., power and stimulation data) to the internal coil via a radio frequency (RF) link. The internal coil is typically a wire antenna coil comprised of multiple turns of electrically insulated single-strand or multi-strand platinum or gold wire. The electrical insulation of the internal coil is provided by a flexible silicone molding (not shown). In use, implantable receiver unit 232 is positioned in a recess of the temporal bone adjacent auricle 110 of the recipient in the illustrated embodiment.

In the illustrative embodiment, stimulation arrangement 250A is implanted in middle ear 105. For ease of illustration, ossicles 106 have been omitted from FIG. 2B. However, it should be appreciated that stimulation arrangement 250A can be implanted without disturbing ossicles 106 in the illustrated embodiment.

Stimulation arrangement 250A comprises an actuator 240, an artificial incus and an optional stapes prosthesis 252 and a coupling element 251. In this embodiment, stimulation arrangement 250A is implanted and/or configured such that a portion of artificial incus and optional stapes prosthesis 252 abuts an opening in one of the semicircular canals 125. For example, in the illustrative embodiment, artificial incus and optional stapes prosthesis 252 abuts an opening in horizontal semicircular canal 126. It would be appreciated that in alternative embodiments, stimulation arrangement 250A is implanted such that artificial incus and optional stapes prosthesis 252 abuts an opening in posterior semicircular canal 127 or superior semicircular canal 128.

As noted above, a sound signal is received by one or more microphones 224, processed by sound processing unit 226, and transmitted as encoded data signals to internal receiver 232. Based on these received signals, stimulator unit 220 generates driving signals which cause actuation of actuator 240. The driving signals can be, e.g., electrical and/or optical. This actuation is transferred to artificial incus and optional stapes prosthesis 252 such that a wave of fluid motion is generated in horizontal semicircular canal 126. Because, vestibule 129 provides fluid communication between the semicircular canals 125 and the median canal, the wave of fluid motion continues into median canal, thereby activating the hair cells of the organ of Corti. Activation of the hair cells causes appropriate nerve impulses to be generated and transferred through the spiral ganglion cells (not shown) and auditory nerve 114 to the brain (also not shown) where they are perceived as sound.

FIG. 2C is a perspective view of an individual's head, implanted with another type of direct acoustic stimulator 200B in accordance with another embodiment of the present technology.

Direct acoustic stimulator 200B comprises an external component 242 which is directly or indirectly attached to the body of the recipient, and an internal component 244B which is temporarily or permanently implanted in the recipient. As described above with reference to FIG. 2B, external component 242 typically comprises one or more sound input elements, such as microphones 224, a sound processing unit 226, a power source (not shown), and an external transmitter unit (also not shown). Also as described above, internal component 244B comprises an internal receiver unit 232, a stimulator unit 220, and a stimulation arrangement 250B.

In the illustrative embodiment, stimulation arrangement 250B is implanted in middle ear 105. For ease of illustration, ossicles 106 have been omitted from FIG. 2C. However, it should be appreciated that stimulation arrangement 250B can be implanted without disturbing ossicles 106 in the illustrated embodiment.

Stimulation arrangement 250B comprises an actuator 240, an artificial incus and an optional stapes prosthesis 254 and a coupling element 253 connecting the actuator to the stapes prosthesis. In this embodiment stimulation arrangement 250B is implanted and/or configured such that a portion of artificial incus and optional stapes prosthesis 254 abuts round window 121.

As noted above, a sound signal is received by one or more microphones 224, processed by sound processing unit 226, and transmitted as encoded data signals to internal receiver 232. Based on these received signals, stimulator unit 220 generates driving signals which cause actuation of actuator 240. This actuation is transferred to artificial incus and optional stapes prosthesis 254 such that a wave of fluid motion is generated in the perilymph in scala tympani. Such fluid motion, in turn, activates the hair cells of the organ of Corti. Activation of the hair cells causes appropriate nerve impulses to be generated and transferred through the spiral ganglion cells (not shown) and auditory nerve 114 to the brain (also not shown) where they are perceived as sound.

It should be noted that the embodiments of FIGS. 2B and 2C are but two exemplary embodiments of a direct acoustic stimulator, and in other embodiments other types of direct acoustic stimulator are implemented. Further, although FIGS. 2B and 2C provide illustrative examples of a direct acoustic stimulator system, in embodiments a middle ear mechanical stimulation device can be configured in a similar manner, with the exception that instead of the actuator 240 being coupled to the inner ear of the recipient, the actuator is coupled to the middle ear of the recipient. For example, in an embodiment, the actuator stimulates the middle ear by direct mechanical coupling via coupling element to ossicles 106 (FIG. 1), e.g., to incus 109 (FIG. 1).

In an embodiment, the auditory prosthesis includes a measurement circuit configured to measure one or more values of a momentum-indicative parameter of the actuator, and controlled to measure the one or more values while the actuator is de-energized. The one or more values of the momentum-indicative parameter are then used by a control circuit, which is configured to evaluate the one or more values against a reference.

FIG. 3B is a simplified block diagram of an internal component of an exemplary auditory prosthesis including a measuring arrangement, in accordance with another embodiment of the present technology. For ease of explanation, internal receiver unit 232, stimulator unit 220 and stimulation arrangement 250 are labeled with the same numbers as the similarly named and labeled components discussed above with reference to FIGS. 2B and 2C. Further, for simplicity, only those components of the internal component that will be discussed below are illustrated in FIG. 3B, and in actual implementation additional components may be included, such as those discussed above with reference to FIGS. 2B and 2C.

As illustrated, stimulator unit 220 includes a control circuit 402, a signal generator (a driver) 404, a resistor 406, and two voltage measurement circuits 408A and 408B. Control circuit 402 is a circuit (e.g., an Application Specific Integrated Circuit (ASIC) and associated memory) configured for exercising control over stimulator unit 220. For example, control circuit 402 is configured for receiving, from internal receiver unit 232, the encoded data signals regarding the sound and generating the driving signals that cause actuation of actuator 240.

Signal generator 404 (also referred to as an actuator driver) generates/sources the driving signal for causing actuation of actuator 240. The driving signal can be, e.g., a stimulating signal configured to induce a desired percept in the recipient, a conditioning signal that is substantially imperceptible to the recipient, etc. In an embodiment, signal generator 404 has an output impedance, e.g., of 10 ohms. Signal generator 404, in an embodiment, e.g., is a Class D or E amplifier containing circuitry to switch the signal generator output or place the signal generator in a high impedance state. Resistor 406, e.g., is a standard resistor, e.g., a 2.3 ohm resistor in the presently described embodiment; however, in other embodiments, resistor 406 may be other types of resistive elements.

Voltage measurement circuit 408A is illustrated as connected to opposite ends of resistor 406. Voltage measurement circuit 408A may include any type of circuitry configured to output a signal indicative of the voltage across resistor 406. For example, in an embodiment, voltage measurement circuit 408A comprises a differential amplifier that takes as inputs the signals on opposite sides of resistor 406 and then amplifies the difference in the voltage between the two sides. As illustrated, voltage measurement circuit 408A provides the measured voltage to control circuit 402. Further, in embodiments, voltage measurement circuit 408A comprises an analog to digital converter (ADC) that digitizes the measured voltage before providing the measured voltage to control circuit 402.

Actuator 240 can be any type of device suitable for generating mechanical movement. In an embodiment, e.g., actuator 240 comprises a transducer element having a magnetic coil (e.g., a linear resonant actuator) or a piezoelectric element. Actuator 240 can be implemented, e.g., as a Microelectromechanical System (MEMS) structure (e.g., a comb-drive MEMS) in an embodiment. Voltage measurement circuit 408B is illustrated as connected on opposite sides of actuator 240. As configured, voltage measurement circuit 408B measures the voltage drop across actuator 240. Voltage measurement circuit 408B may include circuitry such as discussed above with reference to voltage measurement circuit 408A for measuring and outputting the measured voltage. As illustrated, voltage measurement circuit 408B provides the measured voltage to control circuit 402. Although the illustrated embodiment includes two voltage measurement circuits 408A and 408B, in other embodiments only one of the voltage measurement circuits is included.

When an actuator is de-energized (e.g., its terminals are disconnected (or left floating)), momentum of the actuator creates a back electromotive force (back-EMF). Back-EMF (BEMF) is a voltage generated by evanescing movement of the de-energized actuator. For example, if the actuator is linear resonant actuator, the back-EMF is generated by movement of the armature that induces a magnet field which manifests, e.g., as a voltage across the terminals of the actuator.

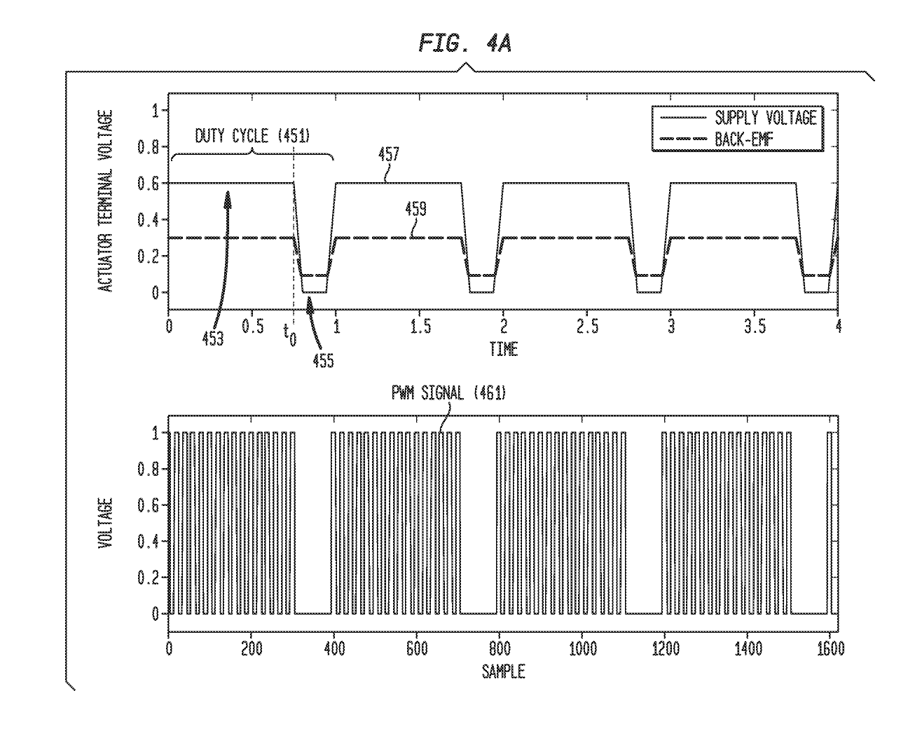

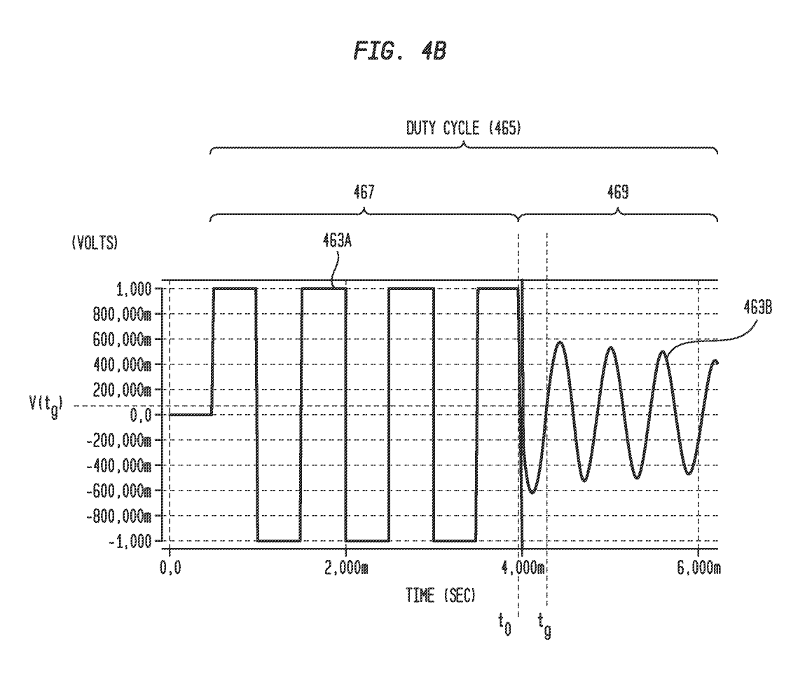

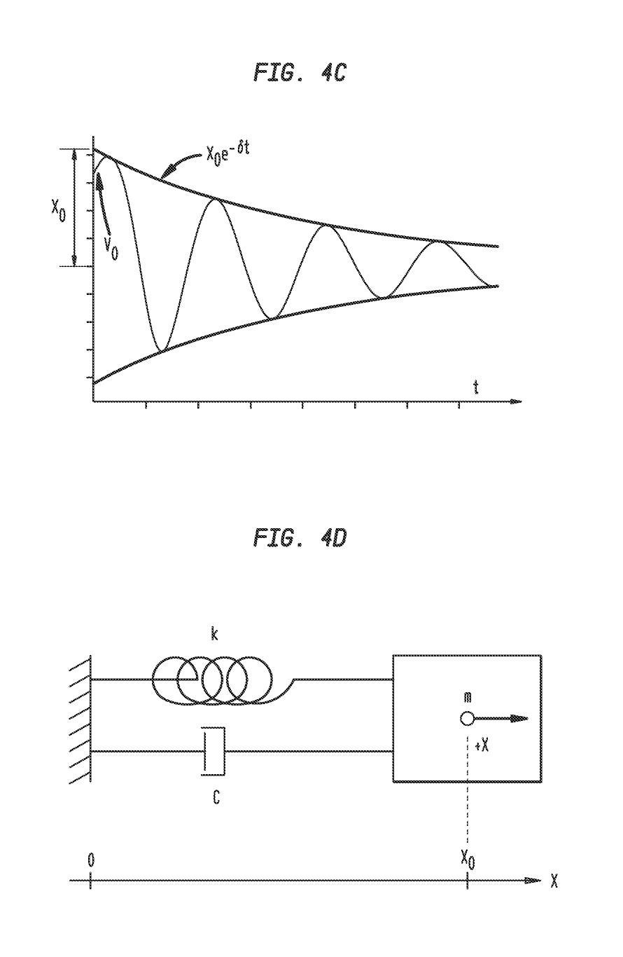

FIG. 4A illustrates waveforms representing an illustrative example of waveforms appearing on terminals of an actuator. Actuators are typically energized (or driven) according to a duty cycle, e.g., duty cycle 451, that includes at least one on-duty phase 453 and at least one off-duty phase 455, e.g., one of each phase. Energizing the actuator corresponds to the on-duty phase 453. De-energizing the actuator corresponds to the off-duty phase 455, which begins at a time t₀. Off-duty phase 455 can be on the order, e.g., a few milliseconds or microseconds. Also illustrated in FIG. 4A is a back-EMF waveform 459, and a pulse-width modulation (PWM) waveform 461. During on-duty phase 453, the driving signal generated by signal generator 404 may be implemented, e.g., as PWM waveform 461.

FIG. 4B illustrates another waveform representing an illustrative example of a waveform appearing on terminals of an actuator. During the on-duty phase 467 of duty cycle 465, waveform 463A corresponds to the voltage of the driving signal appearing on the terminals of the actuator. During the off-duty phase 469 of duty cycle 465, which begins at a time t₀, the voltage of waveform 463B results from back-EMF and decays (or evanesces) according to e^{δt}, as illustrated by the waveform of FIG. 4C. Back-EMF waveform 463B in off-duty phase 469 depends on the amplitude and frequency of waveform 463A during on-duty phase 453. Back-EMF waveform 463B of off-duty cycle 469 is, e.g., in phase with waveform 463A but has significantly reduced amplitudes vis-a-vis waveform 463A.

Without being bound by theory, decaying waveform 463B during off-duty phase 469 can be modeled as follows. It is assumed that the actuator is an electromagnetic actuator as shown in FIG. 4D, which has a mobile mass, m, that is attracted to the origin, 0, with a force arising from, e.g., rigidity (e.g., of a membrane or diaphragm), attraction of the static magnetic field, etc. In FIG. 4D, the rigidity is represented by a spring having a spring constant, k, that moves axially along the direction of the X-axis with a force, f, equal to kx (f=kx, Hooke's law). When stretched, the spring will exert a force on the mass, m, in the opposite direction. It is further assumed that there exists internal damping of the moving mass, m, and mechanical charge, which manifests as a damping force equal to

$$f = c ( \frac{d x}{d t} ) \qquad ( 1 )$$

wherein c is the damping coefficient.

Applying a voltage pulse on the actuator coil will cause a magnetic field change and exert a force on the mass, m, which will give a displacement (or deflection) +x. From Newton's law

ΣF=ma (2)

the following differential equation can be obtained:

$$m \frac{{d}^{2} x}{d t} + kx + c \frac{d x}{d t} = 0. \qquad ( 3 )$$

Rewriting Equation No. 3 yields:

$$\begin{matrix}\frac{{d}^{2} x}{d t} + 2 δ \frac{d x}{d t} + {ω}^{2} x = 0 \\ wherein & ( 4 ) \\ δ = \frac{c}{2 m} \\ and & ( 5 ) \\ {ω}^{2} = \frac{k}{m} . & ( 6 )\end{matrix}$$

Solving Equation No. 4 can be done by assuming that the general form is of the solution from the type

x=Ae^{λ}^{₁}^{t}+Be^{λ}^{₂}^{t} (7)

wherein ₁ and λ₂ are constant.

Another solution to Equation No. 4 can be obtained using Laplace transforms. The result for the case ω²−δ²>0 describes a damped oscillatory motion and is as follows:

$$\begin{matrix}x ( t ) = {x}_{0} {e}^{- δ t} cos \sqrt{{ω}^{2} - {δ}^{2}} t + \frac{( {v}_{0} + δ {x}_{0} )}{\sqrt{{ω}^{2} - {δ}^{2}}} {e}^{- δ t} sin \sqrt{{ω}^{2} - {δ}^{2}} t \\ with & ( 8 ) \\ \frac{d x ( 0 )}{d t} = {v}_{0} . & ( 9 )\end{matrix}$$

A change in the dynamic behavior of an actuator can be observed, for example, as a change in the transfer curve of the actuator. In this context, a transfer curve can take the form of a two-dimensional plot for which the independent variable, e.g., the x-axis, corresponds to frequency, and for which the dependent variable, e.g., the y-axis, is an output characteristic, e.g., actuator speed, actuator displacement/excursion, etc. An example of a change in such a transfer curve is a shift in resonant frequency. Similarly, a change in the mechanical coupling of the actuator to the body can be observed, e.g., as a change in the actuator's transfer curve.

Changes in the frequency vs. output transfer curves can be detected by measuring values of one or more momentum-indicative parameters of the actuator, and comparing the measured values against one or more values of corresponding of one or more references. In this context, references can take the form, e.g., of transfer curves that relate elapsing time (corresponding to the independent variable, e.g., the x-axis in a two-dimensional plot) to an output characteristic (corresponding to the dependent variable, e.g., the y-axis in a two-dimensional plot), e.g., back EMF voltage, actuator speed, etc. Back EMF voltage can be measured on the terminals of the actuator during the off-duty phase. Such measurements can be used by a control circuit to adjust the fitting of the auditory prosthesis (that comprises the actuator) and/or can be used by a trained clinician or audiologist (e.g., during a routing recipient non-surgical check-up and/or an ad hoc, non-surgical intervention related to a recipient's complaint) to adjust the fitting of the auditory prosthesis (that comprises the actuator). Adjusting the fitting can be, e.g., adjusting how the driving signal for the actuator is determined.

References representing the desired transfer curves (e.g., back EMF vs. time, actuator speed vs. time) of the actuator can be determined, for example, as follows. Prior to implantation of the actuator, e.g., at the time of manufacture when the actuator is not subjected to loading, it is assumed that the actuator exhibits an ideal transfer curves. Accordingly, prior to implantation, the back EMF transfer curves and/or the actuator speed transfer curves that the actuator exhibits upon de-energization indirectly represent ideal performance. After implantation, substantially at the point at which the recipient has substantially healed from the surgical implantation procedure, the actuator is subjected to loading and yet it is hoped that the actuator will exhibit performance (“initial performance”) that is substantially the same as its ideal performance. However, the coupling to the recipient (e.g., via his bone, inner ear, middle ear, etc.) might not be ideal and so might change the actuator's transfer curves vis-a-vis the ideal transfer curves. The ideal transfer curves can be used to assess the quality of the coupling. If the coupling falls within an acceptable tolerance, then the initial transfer curves can be regarded as the desired transfer curves, thereby forming the basis for references against which subsequent performance of the actuator can be evaluated vis-a-vis the effects of component aging, fluctuations in environmental factors, impacts to the head that might affect the coupling, etc.

Substantially at the point at which the recipient has substantially healed from the surgical implantation procedure (as discussed above), performance of the actuator can be measured to obtain the corresponding transfer curves, and such transfer curves can be regarded (see discussion above) as representing the desired transfer curves. For example, after driving the actuator with a known test signal, e.g., a single frequency, the actuator is de-energized and its back-EMF waveform vis-à-vis elapsing time is measured in order to create a transfer curve. The voltage (amplitude) of the waveform (driving signal) applied to the actuator terminals during the on-duty phase albeit just before the off-duty phase commences (V_{Ω}) influences the back-EMF waveform. Accordingly, different back-EMF waveforms can be measured corresponding to different values of V_{Ω}. For a given value of V_{Ω}, the actuator can be de-energized and its evanescing back-EMF waveform can be measured and stored, e.g., in the memory of control circuit 402, as a transfer curve. Such a waveform maps, e.g., amplitudes to elapsed times, and can be stored in memory as a look-up table (LUT). Alternatively, an equation can be derived that approximates the amplitude of the waveform as function of time. Such an equation can be stored (e.g., in the memory of control circuit 402) and used (e.g., by control circuit 402) to calculate amplitudes in real time.

FIG. 5 is a flowchart illustrating an exemplary method of assessing the performance of an actuator of an auditory prosthesis, in accordance with another embodiment of the present technology. Flowchart 500 will be described with reference to the above-discussed FIGS. 3A-3B.

Flow in flowchart 500 starts at a block 502 and proceeds to a block 504, where control unit 402 determines a driving signal to be generated/sourced by signal generator 404. Flow proceeds from block 504 to a block 506, where control circuit 402 controls signal generator 404 to energize actuator 240 with the driving signal. Flow proceeds from block 506 to a block 508, where control circuit 402: controls signal generator 404 to de-energize actuator 240, thereby starting the off-duty phase; and starts a timer to track elapsed time since the start of the off-duty phase, namely tₑ.

Flow proceeds from block 508 to a block 510, where control circuit 403 controls voltage measurement circuit 408A and/or 408B to measure, when the elapsed time tₑ equals a given time, t_{g}, a value, VAL(t_{g}), of a momentum-indicative parameter. For example, the momentum-indicative parameter may be a momentum-induced voltage, e.g., a back-EMF voltage, V_{BEMF}, on the terminals of actuator 240. Alternatively, e.g., the momentum-indicative parameter may be the speed of the actuator. Optionally, at block 501, the measured value, VAL(t_{g}) also can be stored, e.g., in the memory of control circuit 402, so as to accumulate a history of the actuator's performance. Such historical data may, e.g., facilitate adjusting the fitting of the auditory prosthesis to the recipient as the implantation site and/or the actuator ages. Such historical data also may, e.g., facilitate determining whether the aging actuator has degraded to a point where replacement of the actuator or the auditory prosthesis as a whole may be appropriate.

Flow proceeds from block 510 to a block 512, where control circuit 402 obtains a value of a reference, REF, appropriate to the time, t_{g}, namely, REF(t_{g}). For example, REF(t_{g}) can be obtained by indexing t_{g} into the desired transfer curve for the actuator. If, for example, there are multiple desired transfer curves available corresponding to different voltages (amplitudes) of the waveform (driving signal) applied to the actuator terminals just before the off-duty phase commences, i.e., corresponding to different values of V_{Ω}, then REF(t_{g}) can be obtained by selecting a transfer curve based on the value of V_{Ω} existing when block 508 was executed, and then indexing t_{g} into the selected one of the desired transfer curves. For example, in the context of a clinical setting in which different test signals (e.g., single frequency signals) can be applied as the driving signal, and there multiple desired transfer curves available corresponding to different single frequencies, then REF(t_{g}) can be obtained by selecting a transfer curve based on the frequency of the test signal when block 508 was executed, and then indexing t_{g} into the selected one of the desired transfer curves. The given time, t_{g}, is selected so that actuator 240 still exhibits a non-negligible momentum. The reference value at given time, t_{g}, i.e., REF(t_{g}), can be, e.g., retrieved from memory (e.g., from a LUT in the memory of control circuit 402), or calculated in real time (e.g., by control circuit 402).

Flow proceeds from block 512 to a block 514, where control circuit 402 compares the measured value, VAL(t_{g}), against the reference value, REF(t_{g}).

Flow proceeds from block 514 to a decision block 516, where control circuit 402 determines if one or more exit conditions (discussed below) have been satisfied. If so (i.e., the one or more exit conditions have been satisfied), then flow proceeds from block 516 to a block 518, where flow ends. If, however, the one or more exit conditions have not been satisfied, then flow proceeds from block 516 to a decision block 520, where control circuit 402 determines whether one or more adjustment conditions have been satisfied. The adjustment conditions can be based, e.g., at least in part on the comparison of block 524. For example, an adjustment condition can be the measured value, VAL(t_{g}), falling outside of a tolerance band (e.g., ±3 dB or ±6 dB vis-à-vis the reference value, REF(t_{g}). Such a condition can be described, e.g., as follows: not true {(REF(t_{g})−3 dB)≦VAL(t_{g})≦(REF(t_{g})+3 dB)}, where VAL(t_{g}) is denominated in units of decibels (dB). For example, in the context of a clinical setting in which different test signals (e.g., single frequency signals) can be applied as the driving signal, the size of the tolerance band can be frequency dependent.

At decision block 520, if the one or more adjustment conditions have been satisfied, then flow proceeds from block 520 to a block 522, where control circuit 402 adjusts how the driving signal is to be determined. Flow proceeds from block 522 to a block 524, where the elapsed time, tₑ, is reset, e.g., is set to zero. From block 524, flow loops back by proceeding to block 504. If, however, the one or more adjustment conditions have not been satisfied, then flow proceeds from block 520 to block 524, skipping block 522.

The method illustrated by the flowchart of FIG. 5 is iterative and can be executed, e.g., with every off-duty phase of the actuator such that the method itself can be described as being executed according to a 100% duty cycle. Also, as illustrated in FIG. 5, the method is iterated, e.g., once for each off-duty phase of the actuator. Alternatively, such a method can be iterated multiple times for each off-duty phase. Also alternatively, such a method can be executed according to a different duty cycle. For example, the method can be executed for an on-duty phase comprising a desired number of duty cycles of the actuator (Ref₂), and then not executed for a second desired number of duty cycles of the actuator (Ref₂). A counter, e.g., can be used started so as to count the elapsing number of duty cycles such that, in decision block 516, an exit condition can be whether the duty cycle count has exceeded Ref₁. Upon satisfying such an exit condition and flow proceeding to end block 518, the counter can be reset and restarted so as to count the elapsing number of duty cycles until the duty cycle count has exceeded Ref₂, at which time the method can be re-executed with flow proceeding from start block 502. Alternatively, a timer can be used instead of a counter.

Other exit conditions can include, e.g., a condition in which a process of turning off the auditory prosthesis has been initiated. For example, if the measured value, VAL(t_{g}), was being stored at block 510 so as to accumulate a history of the actuator's performance, data collected during the turn-off process might be skewed by the turn-off process. To avoid accumulating skewed data, flow might proceed from decision block 516 to end block 518 once a turn-off process has been initiated.

For the method illustrated by the flowchart of FIG. 5, where the measured value, VAL(t_{g}), is back EMF voltage, the method can be described as ‘sensorless.’ In contrast to a method that measures, e.g., speed of the actuator using a specialized sensor such as a laser, the method that measures back EMF voltage using relatively simple voltage measurement circuitry can be regarded as ‘sensorless’ vis-à-vis specialized sensors. The present technology described and claimed herein is not to be limited in scope by the specific example embodiments herein disclosed, since these embodiments are intended as illustrations, and not limitations, of several aspects of the present technology. Any equivalent embodiments are intended to be within the scope of the present technology. Indeed, various modifications of the present technology in addition to those shown and described herein will become apparent to those skilled in the art from the foregoing description. Such modifications are also intended to fall within the scope of the appended claims.

What is claimed is:

1. A computer-implemented method comprising:
energizing an actuator of an auditory prosthesis with a driving signal;
de-energizing the actuator;
obtaining information indicative of a momentum-indicative parameter of the actuator while the actuator is de-energized;
evaluating the obtained information; and
assessing actuator performance based on the action of evaluating.

2. The method of claim 1, wherein:
the action of obtaining information includes measuring one or more values of the momentum-indicative parameter of the actuator while the actuator is de-energized.

3. The method of claim 1, wherein:
the energizing includes applying the driving signal to one or more terminals of the actuator; and
the action of obtaining information includes sensing one or more physical phenomena indicative of the parameter at the one or more terminals.

4. The method of claim 1, wherein:
the momentum-indicative parameter is one of a momentum-induced voltage or a speed of the actuator.

5. The method of claim 1, wherein:
the actuator is a part of a hearing prosthesis;
the hearing prosthesis is configured to apply mechanical stimulation generated by the actuator, to evoke a hearing percept, to at least one of:
an inner ear of a recipient of the actuator;
a middle ear of the recipient; or
a skull of the recipient.

6. The method of claim 1, wherein:
the de-energizing begins at time t₀;
the action of obtaining information includes measuring a given value of one or more values of the momentum-indicative parameter (VALs) at a temporal position t_{g}, after t₀, to obtain VAL(t_{g}); and
the evaluating includes:
obtaining a reference; and
comparing VAL(t_{g}) against the reference.

7. The method of claim 6, wherein:
the action of obtaining a reference includes obtaining a reference appropriate to the time t_{g}, REF (t_{g}); and
the action of comparing VAL(t_{g}) against the reference includes comparing VAL(t_{g}) against REF (t_{g}).

8. The method of claim 6, wherein the comparing includes:
determining if VAL(t_{g}) falls within a desired tolerance band around the reference.

9. The method of claim 6, wherein the action of obtaining a reference includes obtaining a reference value at a time t_{g}, REF (t_{g}), and wherein the action of comparing VAL(t_{g}) against the reference includes comparing VAL(t_{g}) against (REF(t_{g}).

10. An auditory prosthesis comprising:
an actuator configured to generate mechanical vibrations in response to driving signals;
a driver configured to deliver the driving signals to the actuator;
a measurement circuit configured to measure one or more values of a momentum-indicative parameter of the actuator; and
a control circuit configured to:
direct the driver to energize the actuator with a driving signal and then de-energize the actuator;
direct the measurement circuit to measure the one or more values while the actuator is de-energized; and
compare the one or more measured values against one or more references.

11. The auditory prosthesis of claim 10, wherein:
the control circuit is further configured to direct the measurement circuit to measure the one or more values of the parameter while the actuator exhibits at least non-negligible momentum.

12. The auditory prosthesis of claim 11, wherein:
the auditory prosthesis is configured such that the actuator is operatable according to a duty cycle that includes an on-duty phase and an off-duty phase; and
the control circuit is further configured to direct the driver to energize and de-energize the actuator in correspondence to the on-duty and the off-duty phases of the duty cycle, respectively.

13. The auditory prosthesis of claim 10, wherein:
the momentum-indicative parameter is a momentum-induced voltage.

14. The auditory prosthesis of claim 10, wherein:
the auditory prosthesis is configured such that mechanical stimulation originating from the actuator is applied to at least one of an inner ear of the recipient, a middle ear of the recipient or a skull of the recipient.

15. The auditory prosthesis of claim 10, wherein:
the driving signal represents one of:
a desired percept to be induced in the recipient; or
a conditioning signal that is substantially imperceptible to the recipient.

16. The auditory prosthesis of claim 10, wherein:
the driving signal is a first driving signal;
the control circuit is further configured to:
determine the first driving signal;
determine a second driving signal based on the evaluation; and
direct the driver to energize the actuator with the second driving signal.

17. The auditory prosthesis of claim 10, wherein:
the energizing ends and the de-energizing begins at time t₀; and
the control circuit is further configured to:
direct the measurement circuit to make the measurement of a given one of the one or more values (VALs) at a temporal position t_{g}, after t₀, to obtain VAL(t_{g});
obtain the one or more references; and
compare VAL(t_{g}) against the one or more references.

18. A computer implemented method comprising:
obtaining an actuator parameter of an auditory prosthesis that results from the auditory prosthesis being in normal operation for a recipient and from the actuator being de-energized; and
adjusting the normal operation of the auditory prosthesis based on the obtained actuator parameter,
wherein the obtaining action is inaudible to the recipient.

19. The method of claim 18, wherein the action of obtaining includes:
sensing the actuator parameter while the actuator exhibits non-negligible momentum.

20. The method of claim 18, wherein:
the actuator parameter is a back electromotive force (back-EMF).

21. The method of claim 18, further comprising:
energizing the actuator with a driving signal; and
de-energizing the actuator.

22. The method of claim 21, wherein:
the driving signal is configured to cause the actuator to either induce a desired percept in the recipient or generate a conditioning signal that is substantially imperceptible to the recipient.

23. The method of claim 18, wherein the action of obtaining an actuator parameter includes measuring the actuator parameter of the auditory prosthesis while the auditory prosthesis is in normal operation for the recipient and while the actuator is de-energized.
